(19) United States
(12) Patent Application Publication
(10) Pub. No.: US 2009/0273542 A1
(43) Pub. Date: Nov. 5, 2009

(54) CONTENT PRESENTATION APPARATUS, AND CONTENT PRESENTATION METHOD

(76) Inventor: Kakuya Yamamoto, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/095,765

(22) PCT Filed: Dec. 4, 2006
(86) PCT No.: PCT/JP2006/324186

§ 371 Date: Jun. 2, 2008

(30) Foreign Application Priority Data
Dec. 20, 2005 (JP) 2005-366054

(51) Int. Cl. G09G 5/00

(52) U.S. Cl. 345/8

(57) ABSTRACT

To provide a content presentation apparatus which can reduce the cases where presentation information causes users to have a feeling of suddenness or presentation information is ignored even when information that is not adapted to the states of the users is presented.

The content presentation apparatus according to the present invention includes: a purpose information storage unit (103) which stores purpose information; a representative information storage unit (109) which stores representative information included in the purpose information; an adapted information obtaining unit (106) which obtains adapted information adapted to the states of a user; a representative information concatenating unit (111) which concatenates the adapted information and the representative information; and an information presentation unit (120) which presents a content after presenting the concatenated adapted information and representative information for the content.

### TECHNICAL FIELD

The present invention relates to content presentation apparatuses, and in particular to a device which guides a user by presenting contents such as video, BGM and advertising characters in a head mount display (HMD) or a projector.

### BACKGROUND ART

Conventional systems for automatically presenting information which is not specified directly by users include an advertisement presentation system and a system for presenting information according to the states of the users.

Such systems include a system for presenting advertisement when a user requests that the system presents a document by attaching the advertisement to the requested document (refer to Patent Reference 1, for example). With this system, it is possible to guide users to view advertisement related to documents specified by the users.

In addition, similar systems include a system for displaying related advertisement near information for which a user searches the World Wide Web (WWW) through the Internet (refer to Patent Reference 2, for example). With this system, it is possible to guide users to view advertisement related to the information searched for by the users.

In addition, such systems include a car navigation system for presenting information related to a position where a user is present (refer to Patent Reference 3, for example). With this system, it is possible to guide users to view information related to locations where the users are present.

### Patent Reference 1: Japanese Unexamined Patent Application Publication No. 2004-118716

Patent Reference 2: PCT International Publication No. 01/080075, pamphlet

### Patent Reference 3: Japanese Unexamined Patent Application Publication No. 2003-106844

### DISCLOSURE OF INVENTION

### Problems that Invention is to Solve

Conventional systems can present information related to the states of users (the information include a request for a document desired to be read, a search for information desired to be viewed, a present location and the like), but do not present information irrelevant to the states of the users.

However, such scheme for presenting information according to the states of the users cannot solve a problem in presenting guidance in some fields. For example, in the case of a system which guides a user to view an English conversation program when the user on the way to work takes a train, even if the system detects that the user takes the train and automatically reproduces the English conversation program, the user does not always view the program. A conceivable scheme for guiding the user to view the English conversation program is to provide, for example, a preliminary notice of the English conversation program before the user takes the train.

However, to present a sudden preliminary notice before the user takes the train is to present information not adapted to the state of the user. This entails a problem that such nonadapted information may cause the user to have a feeling of suddenness or the information may be ignored when the information is presented. This problem has not yet been addressed.

The present invention has been conceived to solve the problem, and has an object to provide a content presentation apparatus which can reduce the cases where information not adapted to the states of users causes the users to have a feeling of suddenness or the information is ignored when such information is presented.

### Means to Solve the Problems

In order to solve the conventional problem, the content presentation apparatus according to the present invention includes: a content obtaining unit which obtains a content; a representative information obtaining unit which obtains representative information included in the content; an adapted information obtaining unit which obtains adapted information adapted to a state of a user; a concatenation unit which concatenates the adapted information obtained by the adapted information obtaining unit and the representative information obtained by the representative information obtaining unit; and a presentation unit which presents the content obtained by the content obtaining unit after presenting the adapted information and the representative information concatenated by the concatenating unit. Since the adapted information and the representative information are concatenated and presented in this way, it is possible to reduce the cases where the representative information causes users to have a feeling of suddenness and the representative information is ignored even when the representative information is not adapted to the states of the users. Further, since the users have viewed the representative information, it is also possible to reduce the cases where the users have a feeling of suddenness when viewing contents.

Here, the concatenating unit may concatenate the adapted information and the representative information by performing control so that: the adapted information and the representative information are presented temporally in sequence; the representative information is presented as being temporally inserted into the adapted information; the adapted information and the representative information are presented as being temporally overlapped with each other; the adapted information and the representative information are presented spatially adjacent to each other; the representative information is presented as being spatially inserted into the adapted information; or the adapted information and the representative information are presented as being spatially overlapped with each other. This makes it possible to concatenate adapted information and representative information in implementations according to the states and preferences of users.

In addition, the content presentation apparatus may further include a representative information presentation judging unit which judges whether or not the representative information should be presented, and the concatenating unit may concatenate the adapted information and the representative information in the case where the judgment shows that the representative information should be presented. This makes it possible to concatenate adapted information and representative information only in the case where presenting representative information does not become an obstacle in presenting adapted information.

In addition, the representative information presentation judging unit may judge that the representative information should be presented in the case where an information category of the adapted information is not emergency or warning. This provides an advantageous effect of not inhibiting actions of users who have viewed the adapted information because representation information is not presented in the case where the information category of adapted information is emergency or warning.

In addition, the adapted information obtaining unit may obtain information relevant to surroundings of the user as adapted information. This makes it possible to present representative information in addition to information related to the surroundings of users because it is convenient for the users in many cases.

In addition, the adapted information obtaining unit may obtain, as adapted information, information relevant to at least one of time information showing a current time and position information showing a current position of the user. This makes it possible to present representative information in addition to information related to time information and position information because it is convenient for users in many cases.

In addition, the presentation unit is a see-through display carried by the user. This provides an advantageous effect of increasing the possibility that users view the representative information because the representative information naturally come into their sight even while the users are not intentionally viewing the display screen.

It should be noted that the present invention can be implemented not only as the content presentation apparatus but also as: an integrated circuit including the unique units included in the content presentation apparatus; a content presentation method including the steps corresponding to the unique units included in the content presentation apparatus; and a program causing a computer to execute these steps. Further, such program can be distributed via recording media such as CD-ROMs and communication media such as the Internet.

### EFFECTS OF THE INVENTION

The content presentation apparatus according to the present invention concatenates and presents adapted information and representative information, and thus makes it possible to reduce the cases where the representative information causes users to have a feeling of suddenness and the representative information is ignored, even in the case where representative information is not adapted to the states of the users. Further, the content presentation apparatus provides an advantageous effect of reducing the cases where users have such feeling of suddenness when viewing contents by causing the users to view representative information of the contents.

### BRIEF DESCRIPTION OF DRAWINGS

FIG. 1 is an external view of an HMD in a first embodiment of the present invention.

FIG. 2 is a diagram showing the structure of a guiding device in the first embodiment of the present invention.

FIG. 3 is a diagram showing operations of a representative information presentation judging unit in the first embodiment of the present invention.

FIG. 4 is a diagram illustrating an example of a presentation state in the first embodiment of the present invention.

FIG. 5 is a diagram showing an example of presentation information in the first embodiment of the present invention.

FIG. 6 is a diagram showing an example of presentation in the first embodiment of the present invention.

FIG. 7 is a diagram showing an example of information management tables in the first embodiment of the present invention.

FIGS. 8(A), (B), (C), and (D) shows in-sight video of a user carrying the HMD in the first embodiment of the present invention.

FIGS. 9(A), (B), (C), and (D) shows in-sight video of the user carrying the HMD in the first embodiment of the present invention.

FIGS. 10(A), (B), (C), and (D) shows in-sight video of the user carrying the HMD in the first embodiment of the present invention.

FIGS. 11(A), (B), and (C) illustrates a specific example of a concatenation in the first embodiment of the present invention.

FIG. 12 illustrates a specific example of a concatenation in the first embodiment of the present invention.

FIG. 13 illustrates a specific example of a concatenation in the first embodiment of the present invention.

FIG. 14 illustrates a specific example of a concatenation in the first embodiment of the present invention.

### NUMERICAL REFERENCES

101 Purpose setting unit
102 Guidance planning unit
103 Purpose information storage unit
104 State-for-purpose judging unit
106 Adapted information obtaining unit
107 Adaptation state judging unit
109 Representative information storage unit
110 Representative information presentation judging unit
111 Representative information concatenating unit
120 Information presentation unit

### BEST MODE FOR CARRYING OUT THE INVENTION

An embodiment of the present invention is described below with reference to the drawings.

### First Embodiment

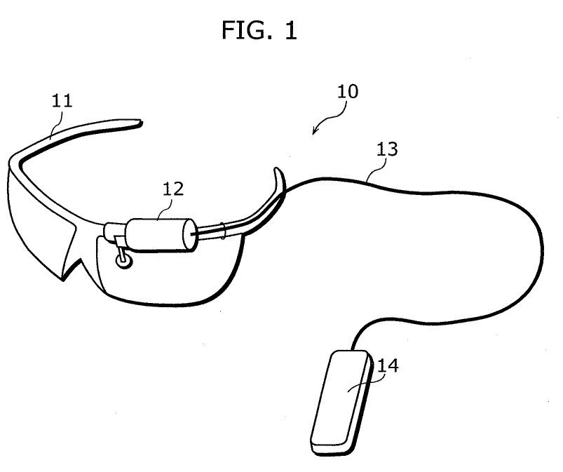

FIG. 1 is an external view of a head mount display (HMD) in a first embodiment of the present invention. A small projector 12 is attached to normal glasses 11. To the projector 12, image data, electric power and the like are sent from a body 14 via a cable 13. The image data sent to the projector 12 is projected through a prism 27 attached along a lens of the glasses 11 at a view angle of approximately 27 degrees. A user can view landscape naturally through the glasses while no image data is being projected. In contrast, while image data is being projected, the user can view a projected image as if the image were floating in the landscape.

It is assumed here that information is obtained from the body 14 via the cable 13. However, with a communication unit, it becomes possible to obtain information through the Internet or the like. In addition, while the HMD for a single eye is shown as an example, an HMD for both eyes can be employed. Further, while a see-through HMD is shown as an example, a non see-through HMD can be employed. A see-through HMD is for presenting, to a user, a virtual image in addition to a natural image formed by incident light coming from outside, and a non see-through HMD is for presenting, to a user, only a virtual image by blocking incident light coming from outside.

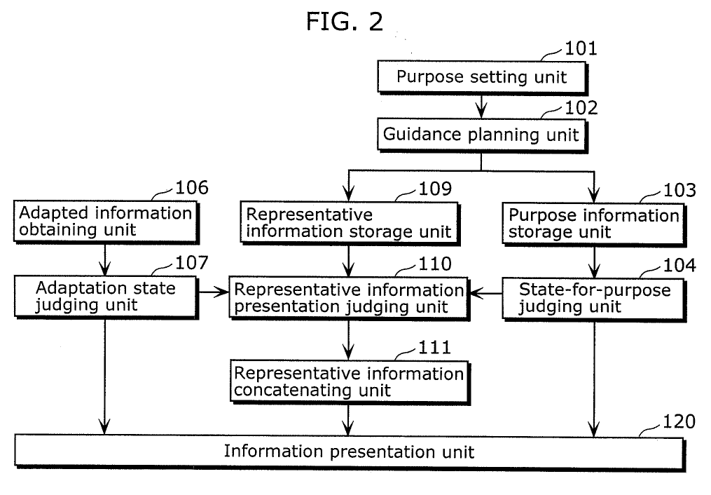

FIG. 2 is a diagram showing the structure of a guiding device in the first embodiment of the present invention. This guiding device presents a content and corresponds to the content presentation apparatus according to the present invention.

The structural diagram of FIG. 2 shows structural elements and the relationship between them.

A purpose setting unit 101 sets a purpose of guidance for a user. Such purpose of guidance (also referred to as “purpose” hereinafter) may be: a purpose related to an action of the user; a purpose related to an outside state; a purpose related to a body condition or a mental condition; or a combination of these. Examples include: viewing an English conversation program in a train on the way to work; arriving at a physical location; a change in body weight or shape; marks in an English examination; an increase in a motivation for learning English. A purpose may be set: by the user; by a person other than the user, for example, a family member, an acquaintance, or a provider of a guidance service; by a guiding device which automatically guesses and sets a purpose; or by a combination of these.

A guidance planning unit 102 corresponds to a content obtaining unit and a representative information obtaining unit according to the present invention. More specifically, the guidance planning unit 102 generates purpose information indicating a purpose of guidance set by the purpose setting unit and representative information including a part of the purpose information. The purpose information corresponds to a content in the present invention. More specifically, when a purpose is to view specific information, purpose information is the specific information, and when a purpose relates to an action of the user, an outside state, a body condition, or a mental condition, purpose information is information for urging the user to take the action or causing the user to find out the state or condition. The following are examples for this. When the purpose is to view the English conversation program, the purpose information is an English conversation program. When the purpose is to arrive at a physical location, the purpose information is information for urging the user to change routes or for notifying the arrival at the destination. When the purpose is a change in the body weight or shape, the purpose information is for suggesting or stopping an action such as having a particular meal or doing exercises or information notifying the achievement of a desired body weight or shape. When the purpose is to increase marks in an English examination or a motivation for learning, the purpose information is an English learning tool itself, information for urging the start of English learning, or information for notifying the achievement of the purpose.

In order to generate purpose information based on purposes, the guidance planning unit holds either a database for generating purpose information or references to an external database. Purpose information according to the purposes which may be set is registered in such databases. Purpose information may be registered: by the user; by a person other than the user such as a provider of a guidance service; by the guidance system which automatically guesses and registers a purpose using registered information or history of the user and other users; or by a combination of these.

Representative information is included in purpose information, and characterized in that it is presented before purpose information is presented in order to increase the advantageous effect of presenting purpose information. The following are examples for this. When the purpose information is an English conversation program, representative information is the opening scene of the English conversation program or an impressive scene. When the purpose information is information indicating “Turn right next” urging the user to change routes, the representative information is information indicating: “A right turn can be made?” notifying options in routes; or “Which way is the next?” announcing that a change is to be urged. When the purpose information is information indicating “Let's have a tea brake!” or “Let's use stairs!” urging the user to take an action such as having a particular meal or doing exercises, the representative information is information indicating “There is tea.” or “Too tired to use these stairs?” notifying options in action before urging the user to take such action. The information such as “Turn right next”, “Let's have a tea break!”, and “Let's use stairs!” are examples of purpose information and corresponds to contents in the present invention.

In order to generate representative information from purpose information, the guidance planning unit clips a main portion from purpose information and generate representative information by adding supplemental information to the clipped portion. In the case where supplemental information such as metadata is added to purpose information in advance, a scheme for determining such main portion may be a scheme for selecting the main portion using a category or numerical value of the supplemental information. In the opposite case where no supplemental information is added, a predetermined scheme may be used. Examples of this include a scheme for clipping an opening scene for five seconds and a scheme for extracting a characteristic word. In addition, as an example of schemes for adding supplemental information to a clipped portion, a scheme for selecting pre-registered supplemental information and adding it to the clipped portion may be used. Information having a format as a template to which the clipped portion is added may be used. The scheme and the information may be combined. Only the portion of purpose information may be used as representative information without adding supplemental information.

The purpose information storage unit 103 stores purpose information generated by the guidance planning unit 102. To store the generated information means to hold the generated information until it is used. Reference to information may be held instead of the information itself.

The purpose information storage unit 103 generates a table called purpose setting table for storing a purpose, and stores the purpose information in the table. The following may be included in the purpose setting table: a purpose information name which is the name of purpose information; a purpose state which is the state of a user at the time when the purpose information is presented; and a presentation state indicating the presence/absence or frequency of the presentation of the purpose information. For example, the following are included in a purpose setting table for storing an English conversation program as purpose information: “Program A” as the name of purpose information; “Immediately after passage of departure station in weekday forenoon” as a purpose state; and “Not yet presented” as a presentation state. The number of purposes may be plural.

The state-for-purpose judging unit 104 judges whether or not the purpose information should be presented. The state-for-purpose judging unit 104 obtains the state of the user from various sensors which obtain the states or statuses of users, and judges whether the current state matches the purpose state. In the case where a match is observed, it judges that the purpose information should be presented. A Global Positioning System (GPS), a clock, a scheduler and the like may be held as such various sensors. Such information may be obtained from external various sensors instead of internal various sensors. As a match between a current state and a state for a purpose, a judgment may be made as to whether a perfect match is observed, and an approximate match within a predetermined range may be regarded as a match. For example, in the case where a purpose information name in a purpose setting table is “Program A” and a purpose state is “Immediately after passage of departure station in weekday forenoon”, the state-for-purpose judging unit 104 judges that it is the forenoon of a weekday with reference to an internal clock. In addition, the state-for-purpose judging unit 104 compares current position information obtained from a GPS carried by the user and position information of a departure station pre-registered by the user. In this way, the state-for-purpose judging unit 104 can judge that the purpose information should be presented at the time when the difference between the position information of the departure station and a current position information becomes or exceeds 100 meters, after the departure of the train that the user has taken after the difference between the position information of the departure station and a current position information becomes within 100 meters.

The adapted information obtaining unit 106 corresponds to an adapted information obtaining unit according to the present invention, and for example, obtains adapted information which is presented according to the state of the user. Adapted information means information adapted to the state of a user. For example, adapted information for the user walking toward a station where the user takes a train may be a remaining time until the train arrives at the station. Adapted information for the user arriving at a station on foot may be a time table for the train. Adapted information for the user in a shopping mall may be the introduction of nearby shops. In other words, it can be said that adapted information relates to the surroundings of the user, and specifically relates to at least one of time information indicating a current time and position information indicating a current position of the user. Further, the adapted information obtaining unit 106 may generate a single table called adapted information table to manage one piece of adapted information. The adapted information table may store adapted information name that is the name of adapted information, an adaptation state indicating a state for presenting adapted information, and the information category indicating the category of the adapted information. For example, an adapted information table including adapted information indicating a remaining time to the arrival of a train includes “Time notification A” as the adapted information name, “7:02 on weekday” indicating, as the adaptation state, 10 minutes before the arrival of the train, and “Normal notification information” as the information category. The number of adapted information may be plural. A scheme according to which the adapted information obtaining unit 106 obtains adapted information may be: a scheme in which a user registers adapted information in advance; a scheme in which a user registers a reference to adapted information stored externally in advance and obtains the external adapted information using, for example, a mobile phone network and a wireless communication network, or the like.

The adaptation state judging unit 107 judges whether or not the adapted information should be presented. The adaptation state judging unit 107 obtains the state of the user from various sensors that obtain the state or status of the user, and judges whether or not a current state matches the adaptation state. In the case where a match is observed, the adaptation state judging unit 107 judges that the adapted information should be presented. As various sensors, a GPS, a clock, a scheduler may be held. Such information may be obtained from various external sensors, not from various internal sensors. As a match between a current state and an adaptation state, a judgment may be made as to whether a perfect match is observed, and an approximate match within a predetermined range may be regarded as a match. For example, in the case where the adapted information name in an adapted information table is “Time notification A” and the adaptation state is “7:02 on weekday”, the adaptation state judging unit 107 can judge that the current time is 7:02 on a weekday with reference to an internal clock, and judges that time notification A should be presented. The various sensors held and used by the adaptation state judging unit 107 may be the same as or different from the various sensors held and used by the state-for-purpose judging unit 104.

The representative information storage unit 109 stores representative information generated by the guidance planning unit. To store the generated information means to hold the generated information until it is used. Reference to information may be held instead of the information itself. The representative information storage unit 109 generates a single table called representative information table to store one piece of representative information, and stores the representative information using the table. Representative information may include a representative information name that is the name of the representative information, purpose information indicating which representative information includes a portion of the purpose information, and a concatenation state indicating a condition for concatenating and presenting the representative information to adapted information. For example, a representative information table for storing an opening scene of an English conversation program as representative information includes: “Representation information A” as the representative information name; “Program A” indicating the English conversation program as purpose information; “Information category of adapted information is not warning information” as a concatenation condition. The number of representative information may be plural.

The representative information concatenating unit 110 corresponds to a representative information presentation judging unit according to the present invention. More specifically, the representative information concatenating unit 110 judges whether or not the representative information should be presented based on a judgment made by the adaptation state judging unit 107 and a judgment made by the state-for-purpose judging unit 104. Such judgment operations will be described later.

The representative information concatenating unit 111 corresponds to a concatenating unit according to the present invention. More specifically, the representative information concatenating unit 111 controls the presentation of the representative information so as to concatenate the representative information to the adapted information, based on the judgment made by the representative information presentation judging unit 110. For example, in the case where adapted information is a time notification A of “10 minutes before arrival of train” and representative information is the opening scene (representative information A) of the English conversation program, presentation control is performed so that the representative information A is presented next to the time notification A when the representative information A is concatenated with the time notification A and presented. A concatenation is not limited to a temporal concatenation, and a concatenation may be a spatial concatenation (a scheme of presenting first information spatially close to second information) or a combination of a temporal concatenation and a spatial concatenation. In addition, a concatenation may be a presentation scheme of temporally or spatially inserting one of adapted information and representative information into the other or to overlap with the other. Specific concatenation examples will be described later in detail.

The information presentation unit 120 corresponds to the presentation unit according to the present invention. More specifically, the information presentation unit 120 presents the purpose information based on the judgment made by the state-for-purpose judging unit 104, presents the adapted information based on the judgment made by the adaptation state is judging unit 107, and concatenates and presents the representative information to and with the adapted information under control by the representative information concatenating unit 111.

The information presentation unit 120 presents purpose information to the user (by displaying the purpose information or outputting audio and vibration, and the like). For example, an English conversation program is automatically presented on a display screen of an HMD carried by the user. The information presentation unit 120 presents adapted information to the user (by displaying the purpose information or outputting audio and vibration, and the like). The information presentation unit 120 presents, for example, “10 minutes before arrival of train” as time notification information A at 7:02 on the display screen of the HMD carried by the user on the way to a departure station. Likewise, it presents “5 minutes before arrival of train” at 7:07. The information presentation unit 120 may be, for example, an HMD or a projector that can present video and audio to a user. Such HMD may be, for example, a see-through display, a face-mount display, an eye-glass type display, a retina-scanning display, or the like. In addition, the information presentation unit may be a processing unit which transmits an instruction to a device other than the guidance device.

It should be noted that the respective units in FIG. 2 may be or may not be on a single computer. For example, all the units in FIG. 2 may be included in a single HMD, the purpose setting unit 101 may be in another device, and the guidance planning unit 102 may be a server device on the Internet. In addition, these units may be distributed across several computers. For example, there may be separated information presentation units one of which presents purpose information and the other one of which presents adapted information and representative information. In addition, each unit in FIG. 2 may be plural. For example, there may be two information presentation units. Several users may share each unit in FIG. 2.

Next, operations of the guiding device are described.

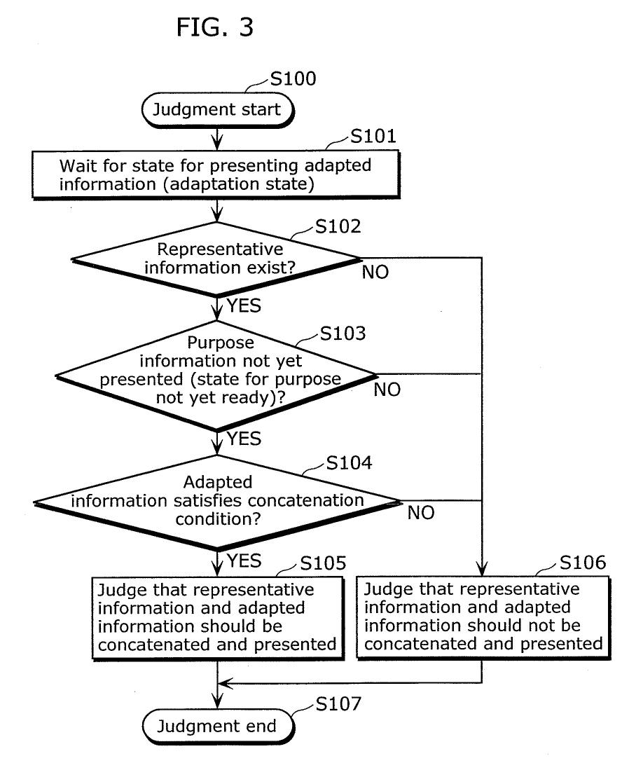

FIG. 3 shows operations of the representative information presentation judging unit 110 of the guidance device in FIG. 2.

Descriptions are given of operations for surely guiding the user carrying a see-through HMD to view the English conversation program in a train. The see-through HMD not only automatically reproduces the English conversation program after the user takes the train but also guiding the user to view the opening scene of the English conversation program on the way to the departure station sometimes, as described below.

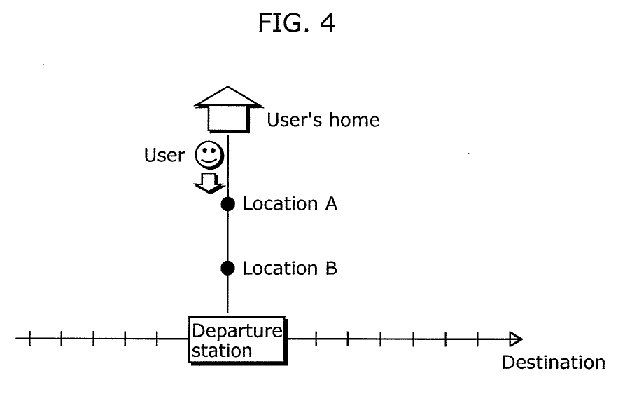

FIG. 4 is a diagram showing the positional relationship between the departure station and the user. The user leaves user's home in the morning, moves to the departure station on foot, and takes the train at the departure station. The train moves toward the right direction in the diagram. The user is present between user's home and a location A at first, and then the user is walking toward the departure station. The HMD displays “10 minutes before arrival of train” to the user at the location A, and then displays the opening scene of the English conversation program. Likewise, The HMD displays “5 minutes before arrival of train” to the user at a location B, and then displays the opening scene of the English conversation program. Subsequently, the user takes the train at the departure station. After the train departs from the station, the HMD starts automatic reproduction of the English conversation program.

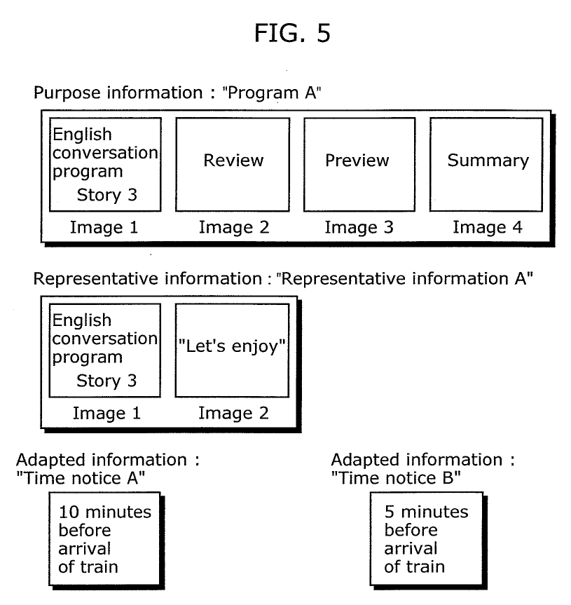

FIG. 5 is a diagram showing purpose information, representative information, and adapted information for performing the above operations. The numerals of an image 1 and an image 2 included in the purpose information and the representative information show the display order. In other words, the image 2 is displayed after the image 1 is displayed.

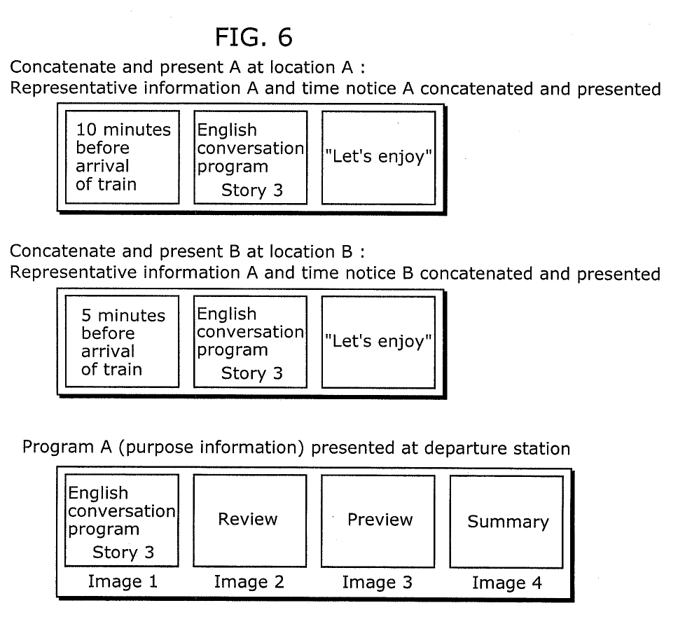

FIG. 6 is a diagram showing information presented by the HMD which performs the above operations.

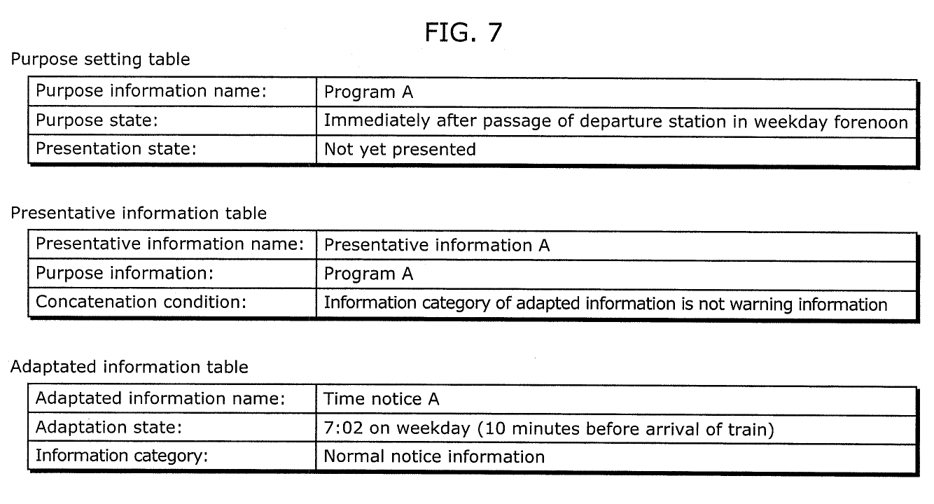

The following operations are the same as the above-described descriptions of the respective units: the purpose information “Program A” is generated by the guidance planning unit in FIG. 5, and is stored by the purpose information storage unit; and a judgment on the presentation is made by the state-for-purpose judging unit, and is presented by the information presentation unit. The purpose setting table in FIG. 7 shows that the purpose information storage unit stores the “Program A”. The operations ending with the storage of the representative information “Representative information A” in FIG. 5 are also the same as the above-described descriptions of the purpose setting unit, the guidance planning unit, and the representative information storage unit. The representative information table in FIG. 7 shows that the representative information storage unit stores the “Representative information A”. The following operations are the same as the above-described descriptions of the respective units: the adapted information “Time notification A” and “Time notification B” in FIG. 5 are obtained by the adapted information obtaining unit; and a judgment on the presentation is made by the adaptation state judging unit, and is presented by the information presentation unit. The adapted information table in FIG. 7 shows that the adapted information obtaining unit manages “Time notification A”.

Next, operations that the representative information presentation judging unit 110 performs to judge whether the representative information should be concatenated with and displayed with the adapted information are described with reference to FIG. 3.

A judgment processing starts with S100, and a transition to the operation of S101 is made.

A state for presenting adapted information (adaptation state) is waited for (S101), and a transition to the operation of S102 is made. This process prevents representative information from being presented while the user is between user's home and the location A and between the location A and the location B. At the time when the adaptation state judging unit judges that the time notification A should be presented after the user arrives at the location A, the waiting process of S101 is completed and a transition to the next operation is made.

A judgment on whether representative information exists or not is made (S102). A transition to the operation of S103 is made in the case where it exists, and a transition to the operation of S106 is made in the opposite case where it does not exist. The representative information presentation judging unit 110 checks that there exists the “Representative information A” (the opening scene of the English conversation program) as representative information.

A judgment on whether the purpose information has not yet been presented or not is made (S103). A transition to the operation of S104 is made in the case where it has not yet been presented, and a transition to the operation of S106 is made in the opposite case where it has already been presented. The representative information presentation judging unit 110 identifies that the purpose information corresponding to the representative information A is the program A with reference to the purpose information column in the representative information table first.

Next, the representative information presentation judging unit 110 requests the purpose state judging unit 104 to judge the presentation state of the program A. The state-for-purpose judging unit 104 makes a response that the presentation state of the program A is “Not yet displayed” to the representative information presentation judging unit 110 with reference to the presentation state column of the purpose setting table in the purpose information storage unit 103. This allows the representative information presentation judging unit 110 to judge that the purpose information has not yet been presented.

It should be noted that the restriction of surely making a transition to S104 in the case where purpose information has not yet been presented may be released. For example, in the case where a remaining time to satisfy a state for purpose is 30 minutes or more, a transition to S106 may be made.

A judgment on whether the adapted information satisfies a concatenation condition is made (S104). A transition to S105 is made in the case where the concatenation condition is satisfied, and a transition to S106 is made in the case where it is not satisfied. The representative information presentation judging unit 110 obtains a concatenation condition that “Information category of adapted information is not warning information” with reference to the concatenation condition column of the representative information table. Further, the representative information presentation judging unit 110 requests the adaptation state judging unit 107 to judge the information category of the time notification A. The adaptation state judging unit 107 notifies the representative information presentation judging unit 110 of the fact that the information category of the time notification A is “Normal notice information” with reference to the information category column of the adapted information table in the adapted information obtaining unit 106. This allows the information presentation judging unit 110 to judge that the time notification A satisfies a concatenation condition because the normal notice information is not warning information.

It should be noted that a judgment made in S104 is not limited to a judgment on whether it is warning information or not. A judgment standard that a concatenation condition is satisfied may be set stricter as the degree of the adapted information increases, for example, the adapted information is an warning or an emergency notice which requires the user to take an immediate action or be more attentive to the information.

A judgment that the representative information should be concatenated with and displayed with the adapted information is made (S105), and a transition to the operation of S107 is made.

A judgment that the representative information should neither be concatenated with nor displayed with the adapted information is made (S106), and a transition to the operation of S107 is made.

The judgment processing ends with S107.

By performing the above operations, the “Representative information A” that is the opening scene of the English conversation program is presented next to “10 minutes before arrival of train” at the location A, as shown in FIG. 6. Likewise, the “Representative information A” is presented next to “5 minutes before arrival of train” at the location A, as shown in FIG. 6. In addition, the representative information is never suddenly presented at a location other than the location A and location B.

More detailed descriptions of the embodiment of the present invention is provided below.

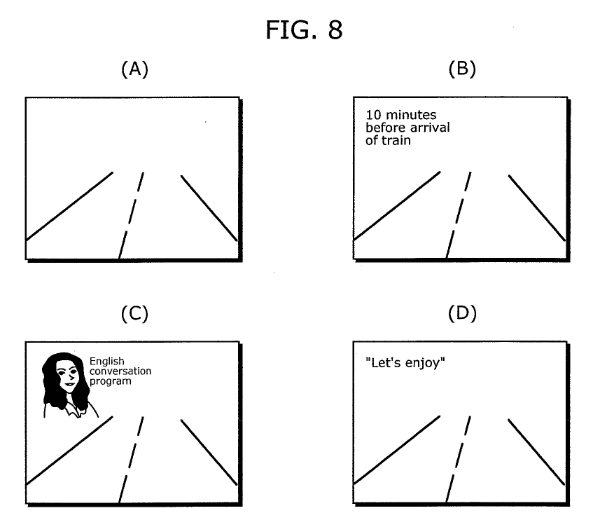

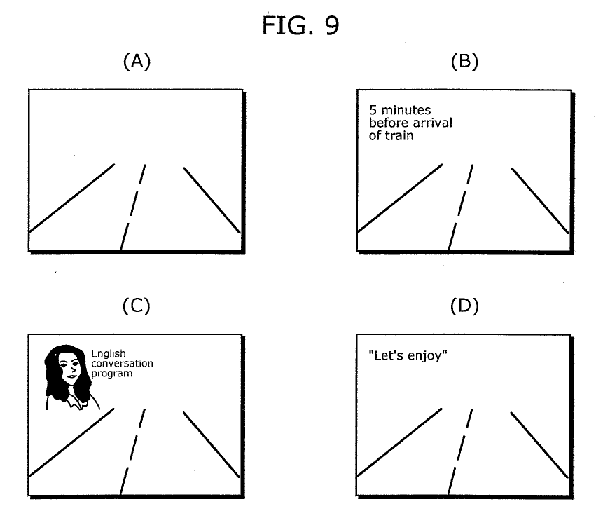

FIG. 8 and FIG. 9 are diagrams showing in-sight video of the user carrying the HMD 10. It is assumed here that the user is moving from user's home to a departure station on foot.

As shown in FIG. 8(A), the user is viewing the route to the departure station while the user is between his/her home and the location A. When the user arrives at the location A, the user views the display of “10 minutes before arrival of train” in the upper left of his/her sight, as shown in FIG. 8(B). Immediately after that, the user views the opening scene of the English conversation program in the upper left of his/her sight, as shown in FIG. 8(C). Immediately after that, the user views the display of “Let's enjoy” in the upper left of his/her sight, as shown in FIG. 8(D). After walking for a while, the user views the route to the departure station, as shown in FIG. 9(A). When arriving at the location B, the user views the display of “5 minutes before arrival of train” in the upper left of his/her sight, as shown in FIG. 9(B). Immediately after that, the user views the opening scene of the English conversation program in the upper left of his/her sight, as shown in FIG. 9(C). Immediately after that, the user views the display of “Let's enjoy” in the upper left of his/her sight, as shown in FIG. 9(D).

Next, a description is given of a case where the information category of the adapted information is emergency or warning.

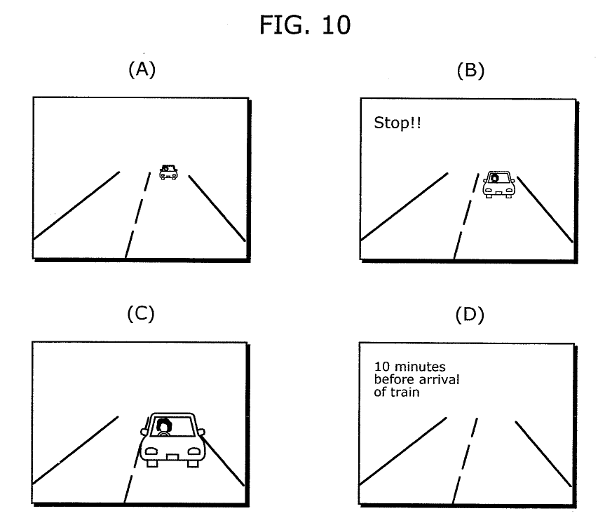

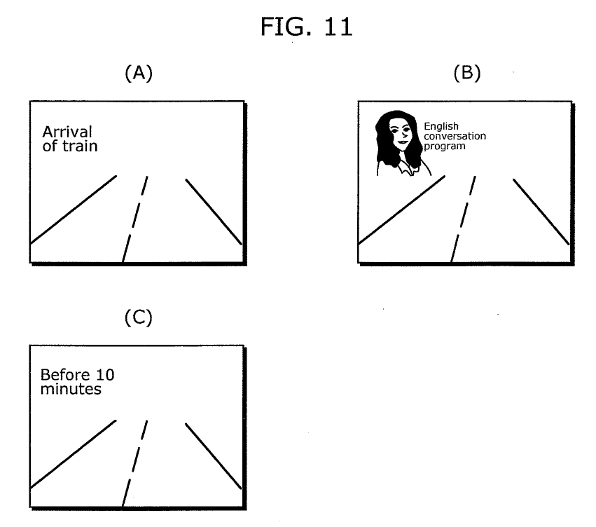

FIG. 10 is a diagram showing in-sight video of the user carrying the HMD 10. As shown in FIG. 10(A), it is assumed here that a bicycle is approaching, in the forward direction, the user moving toward the departure station on foot. In this case, the user views the display of “Stop!!” in the upper left of his/her sight, as shown in FIG. 10(B). Since this display is warning, the opening scene of the English conversation program is not displayed next to “Stop!!”, as shown in FIG. 10(C). When arriving at the location A, the user views the display of “10 minutes before arrival of train” in the upper left of his/her sight, as shown in FIG. 10(D). Immediately after that, the user views the opening scene of the English conversation program and the like, as described earlier, and thus a detailed description for this is omitted.

Here, the adapted information “10 minutes before arrival of train” is presented at the time shown in FIG. 10(D), but it should be noted that the present invention is not limited to this. For example, in the case where a warning such as “Stop!!” is presented, information irrelevant to this warning may not be presented for a predetermined time. For example, in the case where a warning such as an earthquake flash report is presented, it is sometimes desirable that escape route information is preferentially presented next to the report. In such a case, the adapted information “10 minutes before arrival of train” is not presented. Warning levels may be set in order to make appropriate judgments as to whether adapted information should be presented or not. It is possible to prevent a trouble that the presentation of adapted information is unnecessarily restricted so that the adapted information is not presented only when a warning of a predetermined level or more is presented.

Next, specific concatenation examples are described.

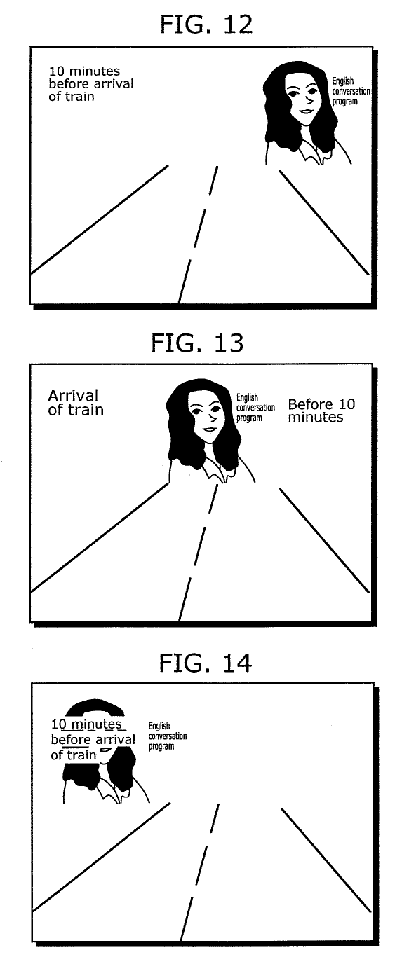

FIG. 8 and FIG. 9 show the examples where adapted information and representative information are presented in a temporal sequence, but there are various concatenation manners. For example, representative information may be presented as being temporally inserted into adapted information. As another example, adapted information and representative information may be presented as being temporally overlapped with each other, as shown in FIG. 12. Presenting adapted information and representative information as being temporally overlapped with each other is the same as presenting adapted information and representative information as being spatially adjacent to each other. As another example, representative information may be presented as being spatially inserted into adapted information. As another example, adapted information and representative information may be presented as being spatially overlapped with each other, as shown in FIG. 14. In this way, it is possible to concatenate adapted information and representative information in various manners according to the states and preferences of the user. Here is illustrated only the case where the opening scene of the English conversation program is taken as an example of representative information, but it should be noted that an image of “Let's enjoy” may be added to the opening scene to be used as representative information, as a matter of course.

As described earlier, the present invention allows adapted information and representative information to be concatenation and presented, and thus makes it possible to reduce the cases where representative information causes the user to have a feeling of suddenness or the information may be ignored. Further, the present invention provides an advantageous effect of reducing a feeling of suddenness in viewing a content because representative information of the content is viewed.

It should be noted that the order of the operations from S101 to S104 shown in FIG. 3 may be modified as long as the operations or judgments of S101 to S104 are completed before the operations of S105 and S106. Further, the operations shown in FIG. 3 may be executed immediately in sequence, may be executed with an interval, or may be executed in parallel.

It should be noted that judgments from S101 to S104 do not always have to be made using forced choice, and may be made by using probability calculation.

The embodiment can be implemented as predetermined program data for causing a CPU to interpret and execute the above-described processing procedures. In this case, the program data may be installed in a storage device using a storage medium, or may be directly executed using the recording medium. Recording media include: semiconductor memories such as ROMs, RAMs and flash memories; magnetic disc memories such as flexible discs and hard discs; optical discs such as CD-ROMs, DVDs and BDs; and memory cards such as SD cards. In addition, the concept of recording media includes communication media such as telephone networks and carrier paths.

### INDUSTRIAL APPLICABILITY

The content presentation apparatus according to the present invention is applicable to HMDs, projectors, car navigation systems and the like required to reduce the cases where presentation information causes users to have a feeling of suddenness or presentation information is ignored even when information that is not adapted to the states of the users is presented.

1. A content presentation apparatus which presents a content, comprising:
a content obtaining unit operable to obtain the content;
a representative information obtaining unit operable to obtain representative information included in the content;
an adapted information obtaining unit operable to obtain adapted information adapted to a state of a user;
a concatenation unit operable to concatenate the adapted information obtained by said adapted information obtaining unit and the representative information obtained by said representative information obtaining unit; and
a presentation unit operable to present the content obtained by said content obtaining unit after presenting the adapted information and the representative information concatenated by said concatenating unit.

2. The content presentation apparatus according to claim 1,
wherein said concatenating unit is operable to concatenate the adapted information and the representative information by performing control so that: the adapted information and the representative information are presented temporally in sequence; the representative information is presented as being temporally inserted into the adapted information; the adapted information and the representative information are presented as being temporally overlapped with each other; the adapted information and the representative information are presented spatially adjacent to each other; the representative information is presented as being spatially inserted into the adapted information; or the adapted information and the representative information are presented as being spatially overlapped with each other

3. The content presentation apparatus according to claim 1, further comprising
a representative information presentation judging unit operable to judge whether or not the representative information should be presented,
wherein said concatenating unit is operable to concatenate the adapted information and the representative information in the case where the judgment shows that the representative information should be presented.

4. The content presentation apparatus according to claim 3,
wherein said representative information presentation judging unit is operable to judge that the representative information should be presented in the case where an information category of the adapted information is not emergency or warning.

5. The content presentation apparatus according to claim 1,
wherein said adapted information obtaining unit is operable to obtain information relevant to surroundings of the user as adapted information.

6. The content presentation apparatus according to claim 1,
wherein said adapted information obtaining unit is operable to obtain, as adapted information, information relevant to at least one of time information showing a current time and position information showing a current position of the user.

7. The content presentation apparatus according to claim 1,
wherein said presentation unit is a see-through display carried by the user.

8. A content presenting method for presenting a content, comprising:
a content obtaining step of obtaining the content;
a representative information obtaining step of obtaining representative information included in the content;
an adapted information obtaining step of obtaining adapted information adapted to a state of a user;
a concatenation step of concatenating the adapted information obtained in said adapted information obtaining step and the representative information obtained in said representative information obtaining step; and
a presentation step of presenting the content obtained in said content obtaining step after presenting the adapted information and the representative information concatenated in said concatenating step.

9. A program for presenting a content, said program causing a computer to execute:
a content obtaining step of obtaining the content;
a representative information obtaining step of obtaining representative information included in the content;
an adapted information obtaining step of obtaining adapted information adapted to a state of a user;
a concatenation step of concatenating the adapted information obtained in said adapted information obtaining step and the representative information obtained in said representative information obtaining step; and
a presentation step of presenting the content obtained in said content obtaining step after presenting the adapted information and the representative information concatenated in said concatenating step.

10. A computer-readable recording medium on which a program for presenting a content is recorded, the program causing a computer to execute:
a content obtaining step of obtaining the content;
a representative information obtaining step of obtaining representative information included in the content;
an adapted information obtaining step of obtaining adapted information adapted to a state of a user;
a concatenation step of concatenating the adapted information obtained in said adapted information obtaining step and the representative information obtained in said representative information obtaining step; and
a presentation step of presenting the content obtained in said content obtaining step after presenting the adapted information and the representative information concatenated in said concatenating step.

11. A content presentation integrated circuit which presents a content, comprising:
a content obtaining unit operable to obtain the content;
a representative information obtaining unit operable to obtain representative information included in the content;
an adapted information obtaining unit operable to obtain adapted information adapted to a state of a user;
a concatenation unit operable to concatenate the adapted information obtained by said adapted information obtaining unit and the representative information obtained by said representative information obtaining unit; and
a presentation unit operable to present the content obtained by said content obtaining unit after presenting the adapted information and the representative information concatenated by said concatenating unit.
